(19) United States
(12) Patent Application Publication
(10) Pub. No.: US 2015/0359245 A1
(43) Pub. Date: Dec. 17, 2015

(54) DECORATED EDIBLE BAKING LINER AND METHOD THEREOF

(71) Applicant: GILRO LTD., Bet Shemesh (IL)

(72) Inventor: Avi GELBARD, Tel Aviv (IL)

(21) Appl. No.: 14/305,292

(22) Filed: Jun. 16, 2014

(51) Int. Cl. A23L 1/00; A23P 1/10

(52) U.S. Cl. CPC A23L 1/0067; A23P 1/10; A23V 2002/00

(57) ABSTRACT

A decorated edible baking liner for accommodating a bakable article, characterized by an edible paper in a strap-like confining printable structure having at least one first end and at least one second end. The first end includes at least one interlocking member for joining to a second end to form a three dimensional (3D) configuration around the circumference of a bakable article.

### FIELD OF THE INVENTION

The present invention relates to a decorated edible printed paper for bakable products and more particularly, the present invention pertains to edible printed paper for bakable products having a three dimensional configuration, printed with decoration images.

### BACKGROUND OF THE INVENTION

Various products for accommodating a baked product are produced, processed, and used in large quantities in a number of applications.

US Patent Publication No. 2011/0171352 discloses an edible baking liner is disclosed which is formed from an edible paper made with large-granule vegetable starch. The liner is baked with the baking product and can be consumed without removing it from the baking product. The edible baking liner can replace the use of an inedible baking liner.

It therefore remains a long felt and unmet need to provide novel means and methods of forming an edible baking liner in an improved and efficient manner.

### SUMMARY OF THE INVENTION

It is an object of the present invention to disclose a decorated edible baking liner for accommodating a bakable object, comprising: an edible paper in a strap-like confining structure; the strap-like confining structure having at least one first end and at least one second end; the first end comprises at least one interlocking member for joining to the second end of the strap-like confining structure to form a 3D configuration around a circumference of the bakable object.

It is another object of the present invention to provide the edible baking liner as defined above, wherein the 3D configuration comprises a bottom and substantially vertical peripheral wall; the bottom is with a shape and diameter compatible with an open bottom created when the liner is formed into the 3D configuration.

It is another object of the present invention to provide the edible baking liner as defined above, wherein the structure is selected from the group consisting of: cupcake, cup shape, shape of the baking tin, pan, tray, plate and a combination thereof.

It is another object of the present invention to provide the edible baking liner as defined above, wherein said strap-like confining structure is printed using an ink jet printer.

It is another object of the present invention to provide the edible baking liner as defined above, wherein the interlocking member has a curved shape or a polygon shape configured to be inserted and joined with the second end.

It is another object of the present invention to provide the edible baking liner as defined above, wherein the edible baking liner comprises at least one of the following components selected from the group consisting of: a color, a flavor, an odor-imparting agent, corn syrup solids, an emulsifier, and a combination thereof.

It is another object of the present invention to provide the edible baking liner as defined above, wherein the edible baking liner is formed using a cutting system configured to cut the edible baking liner into a desired texture.

It is another object of the present invention to provide the edible baking liner as defined above, wherein further includes at least one drying units configured to expose a layer of the edible material to heated air.

It is another object of the present invention to provide the edible baking liner as defined above, wherein the edible paper is approximately 50 to 750 micrometers in thickness.

It is another object of the present invention to provide the edible baking liner as defined above, wherein the edible material is substantially stable in low relative humidity environments.

It is another object of the present invention to provide the edible baking liner as defined above, wherein the edible material is substantially stable when exposed to a temperature above about 90° C.

It is another object of the present invention to disclose a decorated edible baking liner for accommodating bakable object, prepared by the method comprising steps of:
(a) providing an edible baking liner for accommodating a bakable object comprising an edible paper in a strap-like confining structure; the strap-like confining structure having at least one first end and at least one second end; the first end comprises at least one interlocking member for joining to the second end of the strap-like confining structure to form a 3D configuration around a circumference of the bakable object; (b) providing at least one ink jet printer. The aforementioned method additionally comprising steps of printing at least one image on the strap-like confining structure, using the ink jet printer.

It is another object of the present invention to disclose a method for printing an edible baking liner for accommodating baked material, comprising steps of:
(a) providing an edible baking liner for accommodating a bakable object comprising an edible paper in a strap-like confining structure; the strap-like confining structure having at least one first end and at least one second end; the first end comprises at least one interlocking member for joining to the second end of the strap-like confining structure to form a 3D configuration around a circumference of the bakable object, (b) providing at least one ink jet printer. The aforementioned method additionally comprises steps of printing at least one image onto the strap-like confining structure, using the ink jet printer.

It is another object of the present invention to provide the method as defined above, wherein the step of printing an image onto the edible liner is with an edible ink composition.

It is another object of the present invention to provide the method as defined above, wherein the printing of the three 3D configuration sculpture product comprises an edible baking liner in a shape having a bottom, substantially vertical wall and an open top.

It is another object of the present invention to provide the method as defined above, wherein comprising the step of forming a cupcake shape for accommodating baked material.

It is another object of the present invention to provide the method as defined above, wherein the method additionally comprising the step of selecting a structure from the group consisting of: cupcake, cup shape, baking tin shape, a pan shape, a tray shape, a plate shape and a combination thereof.

It is another object of the present invention to provide the method as defined above, wherein the method additionally comprising step of adding to the edible baking liner at least one of the following components selected from the group consisting of: a color, a flavor, an odor-imparting agent, corn syrup solids and a combination thereof.

It is another object of the present invention to provide the method as defined above, wherein the edible material is substantially stable in low relative humidity environments.

It is another object of the present invention to provide the method as defined above, wherein the edible material is substantially stable when exposed to a temperature above about 90° C.

It is another object of the present invention to provide the method as defined above, wherein the method additionally comprising step of cutting the edible baking liner into a desired texture.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a cross section of the edible baking liner of the present invention;

FIG. 2 presents a cross section of the edible baking liner of the present invention;

FIG. 3 presents a schematic view of the edible baking liner of the present invention; and

FIG. 4 presents a flow chart for preparing the edible baking liner of the present invention

### DETAILED DESCRIPTION OF EMBODIMENTS

The following description is provided, alongside all chapters of the present invention, so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide a means and method of an edible baking liner for accommodating baked material, comprising an edible paper in a predefined structure. The edible baking liner is printed in a predefined structure having a three dimension (3D) configuration.

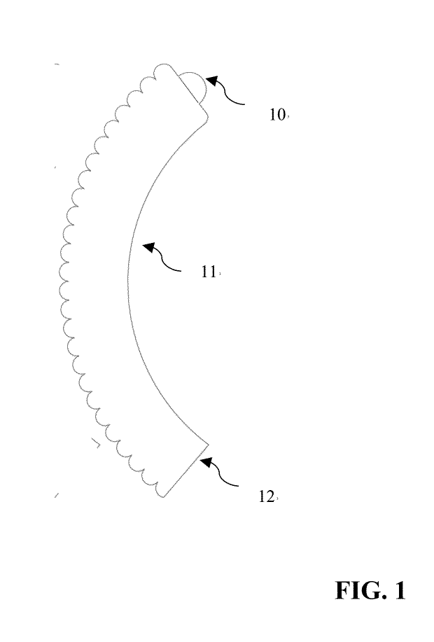

Reference is now made to FIG. 1, which illustrates a decorated edible baking liner for accommodating a microwaveable and/or oven-bakable object, comprising: an edible paper in a strap-like confining structure 11. The strap-like confining structure has at least one first end and at least one second end, the first end comprises at least one interlocking member for joining to the second end of the strap-like confining structure to form a 2 dimension (2D) or 3 dimension (3D) configuration around a circumference of the bakable object.

In another embodiment of the present invention, the strap-like confining structure is printable using an ink jet printer.

In another embodiment of the present invention, the baking cut liner further comprises at least one cut or a slice on one end or edge 12 of the liner, having a length adjacent to accommodate a designed protruding portion on the second end 10 of the liner.

In another embodiment of the present invention, the printing process includes preparing an edible baking sheet using edible ink printing for creating preprinted images with edible food colors upon a confectionery products such as cookies, cakes, or pastries. The Edible Image designs can either be preprinted, or created with an edible printer, a specialty device which transfers an image onto a thin, edible paper. The paper can be made made of starches and sugars and printed on with edible food colors. The images retain color clarity and resist color bleeding, even on high moisture applications.

In another embodiment of the present invention, the edible paper for this process which can be used is rice paper, frosting sheets or any paper which can consumed without harsh effects on a normal human digestive system.

In another embodiment of the present invention, the paper is firm enough to be printed in a standard printer. However, the paper dissolves quickly when brought in contact with moist frosting.

In another embodiment of the present invention, inkjet or bubble jet printer can be used to print whilst avoiding contamination of the edible inks with previously used inks Inkjet or bubble jet printers can be converted to print using edible ink, and cartridges of edible ink are commercially available.

In another embodiment of the present invention, the edible baking liner baking may be used for one time use or may further be configured for several uses.

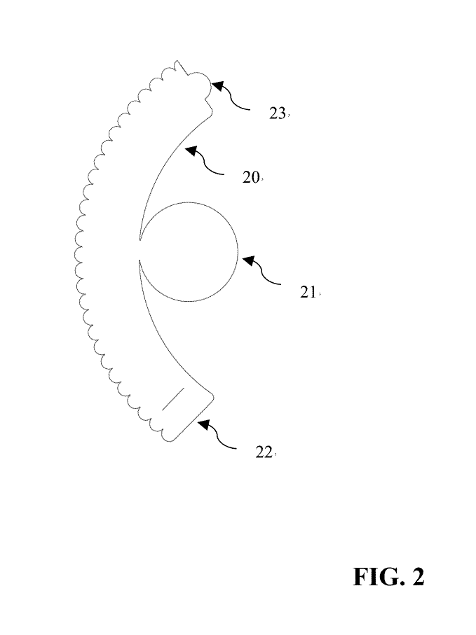

Reference is now made to FIG. 2, which illustrates an edible baking liner which includes a generally planar bottom portion 21 and substantially vertical peripheral wall 20. The vertical peripheral wall 20 is an upwardly portion configured as a peripheral sidewall for accommodating a food product.

The baking cut liner further comprises at least one elongated cut or a slice on one end of the liner 22, having a length adjacent to accommodate a designed protruding portion on the second end 23 of the liner. The protruding portion may be in a structure selected from a group consisting of a round shape, curved shape with or without sharp angles, a square shape, a equiangular polygon, cyclic polygon, equilateral polygon, tangential polygon, regular polygon, end-transitive polygon, rectilinear polygon, monotone polygon and a combination thereof.

In another embodiment of the present invention, the cupcake three dimensional shape is further formed by connecting the protruding portion within the slice located on one end of the baking cut liner.

In another embodiment of the present invention, the peripheral wall is further designed having plurality of curved shape portions on top of the vertical peripheral wall of the cup cake formed.

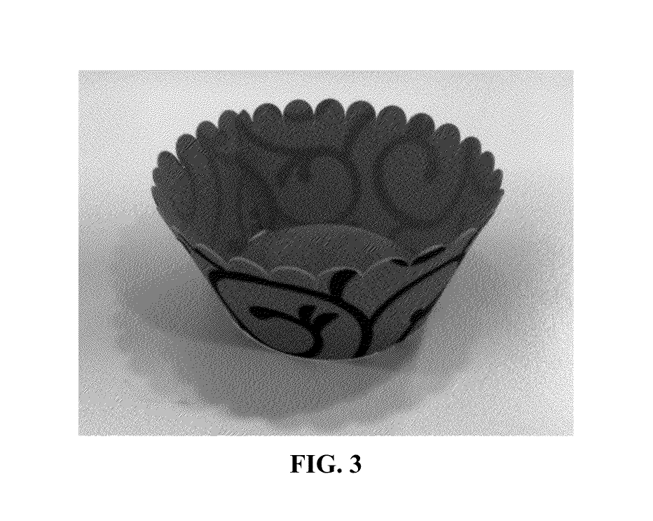

Reference is now made to FIG. 3, which illustrates a decorated edible baking liner cut designed as a cupcake shape having vertical elongated peripheral wall in a 3D configuration and plurality of decorations printed upon.

In another embodiment of the present invention, the baking cut liner further comprises at least one slice or cut on one end, having a diameter adjacent to accommodate a protruding portion on the other end of the liner.

In another embodiment of the present invention, the structure of the edible baking liner is selected from the group consisting of: cupcake, cup shape, shape of the baking tin, pan, tray, plate and a combination thereof.

In another embodiment of the present invention, the edible baking liner is printed in one portion having at least one desired image, furthermore the first and second end of the are designated to be interlockable, thereby forming edible baking liner having 3D configuration.

In another embodiment of the present invention, the edible baking liner is prepared by admixing a glycerin mixture, a powder mixture and an aqueous solution.

In another embodiment of the present invention, the edible baking liner edible baking liner is prepared from the mixture of the components: a starch selected from processed starch and non-processed starch, a sweetening substance, a polyhydric alcohol, a gum, a maltodextrin, water, and a combination thereof.

In another embodiment of the present invention, the edible baking liner comprises at least one of the following components selected from the group consisting of: a color, a flavor, an odor-imparting agent, corn syrup solids, an emulsifier, and a combination thereof.

In another embodiment of the present invention, the edible baking liner edible baking liner is formed using a cutting system configured to cut the edible baking liner into a desired texture.

In another embodiment of the present invention, the edible baking liner includes at least one drying units configured to expose a layer of the edible material to heated air.

In another embodiment of the present invention, the edible baking liner thickness is approximately 50 to 750 micrometers.

In another embodiment of the present invention, the edible baking liner is substantially stable in low relative humidity environments.

In another embodiment of the present invention, the edible material is substantially stable when exposed to a temperature above about 90° C.

The present invention further provides a method of printing an edible baking liner for accommodating baked material, comprising steps of: providing an edible baking liner for accommodating a baked material, comprising: an edible paper in a predefined structure, the structure comprises an elongated strap-shape paper having at least two ends, providing a printer and printing the baking liner in a desired configuration and printing the baking liner in a desired configuration.

The procedure of printing the baking liner in a desired configuration is been pre-formed by using at least one portion and further by joining the first and second ends forming a 3D configuration of the edible baking liner.

In another embodiment of the present invention, the inkjet printing system which can be used are continuous jet or drop-on-demand. In continuous jet inkjet systems, ink is emitted in a continuous stream under pressure through at least one nozzle. The stream is broken up into droplets at a fixed distance from the orifice. Typically, the ink droplets in continuous inkjet systems are formed by a piezoelectric crystal, which is vibrated at controlled frequency adjacent to the ink stream. To control the flow of ink droplets, these inks are charged (by addition of salts and other conductive agents) and relayed in accordance with digital data signals. The droplets are passed through an electrostatic field, which adjusts the trajectory of each droplet. The droplets are either directed back to a gutter for recirculation or to a specific location on the substrate to create the desired character matrix.

In drop-on-demand systems, a droplet is expelled under pressure from a valve directly to a position on the substrate in accordance with the digital data signals. A droplet is not formed or expelled unless it is to be jetted to the substrate. The formation of droplets in drop-on demand systems can either be achieved by a piezoelectric crystal (similar to continuous jet systems) or by a thermal (bubble-jet) technique. The latter technique involves formation of ink droplets by thermally heating ink in the cartridge reservoir thereby forcing ink to be expelled in an “on-demand” basis. Typically, drop-on-demand systems print at a slower rate than continuous jet systems (due to time required to make droplets on demand) but produce higher resolution images.

In another embodiment of the present invention the edible paper can be cut, printed and handled in a substantially similar manner to regular, non-edible paper. Thus, the edible paper does not require special expertise or equipment in order to produce attractive designs and images for decorations. Indeed, the edible paper of the present invention could easily be used in the kitchen of the average private home

In another embodiment of the present invention, a template or a mold in a desired configuration may be used for printing the edible liner.

### Examples

An edible paper is provided and prepared for printing by cutting the edible paper to sheets in a desired shape and size and placing in a tray.

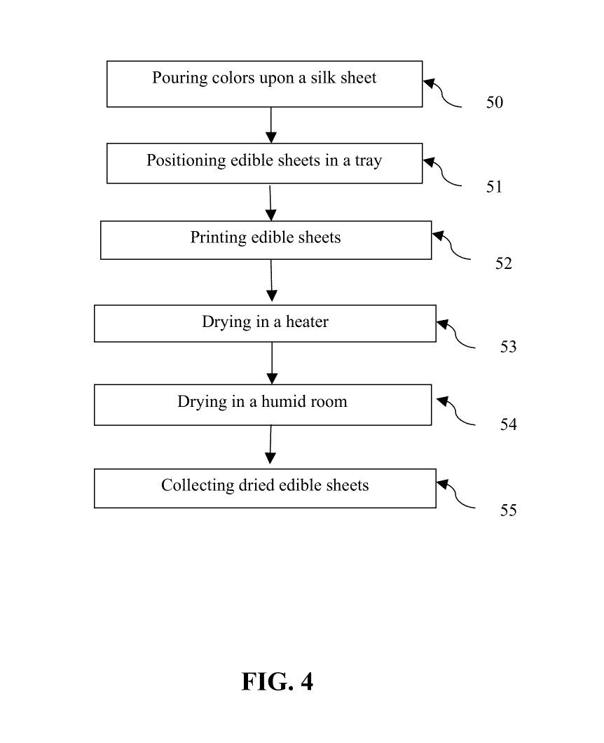

FIG. 4 further illustrates a flow chart schema of a method of printing an edible baking liner for accommodating baked material, comprising the following steps:

(a) providing an edible sheet and a color gel for printing a desired structure or model 50;
(b) Pouring the color gel upon a mesh template and placing the edible sheet upon a template 51.
(c) Printing a desired model 52;
(d) Drying in a heater such as a radiator 53;
(e) Drying the printed edible sheet using a ventilation system in a humid environment 54;
(f) Cutting the printed sheet into a two dimension configuration using an air pressure piston or magnetic drum;
(g) Collecting the printed edible sheet and cutting it to a 3D configuration comprising a bottom and substantially vertical peripheral wall. The 3D configuration is in a structure selected from the group consisting of: a cupcake shape, cup shape, a baking tin shape, a pan shape, a tray shape and a combination thereof.

The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A decorated edible baking liner for accommodating a bakable article, characterized by an edible paper in a strap-like confining printable structure having at least one first end and at least one second end; said first end comprises at least one interlocking member for joining to said second end to form a three dimensional (3D) configuration around a circumference of said bakable article.

2. The edible baking liner of claim 1, wherein said 3D configuration, when formed, is characterized by a bottom and a substantially vertical peripheral wall; said bottom having a shape and diameter compatible with an open bottom.

3. The edible baking liner of claim 1, wherein said structure is selected from the group consisting of cupcake, cup shape, shape of the baking tin, a pan, a tray, a plate and a combination thereof.

4. The edible baking liner according to claim 1, wherein said strap-like confining structure is printable using an ink jet printer.

5. The edible baking liner according to claim 1, wherein said interlocking member has a curve shape or a polygon shape configured to be inserted and joined with the second end.

6. The edible baking liner according to claim 1, wherein said edible baking liner comprises at least one of the following components selected from the group consisting of: a color, a flavor, an odor-imparting agent, corn syrup solids, an emulsifier, and a mixture thereof.

7. The edible baking liner according to claim 1, wherein said edible baking liner is formed using a cutting system configured to cut the edible baking liner into a desired texture.

8. The edible baking liner according to claim 1, wherein said edible paper is approximately 50 to 750 micrometers in thickness.

9. The edible baking liner according to claim 1, wherein said edible material is substantially stable in low relative humidity environments.

10. The edible baking liner according to claim 1, wherein said edible material is substantially stable when exposed to a temperature above about 90° C.

11. A decorated edible baking liner for accommodating bakable object, prepared by the method comprising steps of:
a. providing an edible baking liner for accommodating a bakable object comprising an edible paper in a strap-like confining structure; said strap-like confining structure having at least one first end and at least one second end; said first end comprises at least one interlocking member for joining to said second end of said strap-like confining structure to form a 3D configuration around a circumference of said bakable object; and
b. providing at least one ink jet printer;
wherein said method additionally comprising step of printing at least one image on said strap-like confining structure, using said ink jet printer.

12. A method for printing an edible baking liner for accommodating baked material, comprising steps of:
a. providing an edible baking liner for accommodating a bakable object comprising an edible paper in a strap-like confining structure; said strap-like confining structure having at least one first end and at least one second end; said first end comprises at least one interlocking member for joining to said second end of said strap-like confining structure to form a 3D configuration around a circumference of said bakable object; and
b. providing at least one ink jet printer;
wherein said method additionally comprising step of printing at least one image onto said strap-like confining structure, using said ink jet printer.

13. The method according to claim 12, wherein said step of printing an image onto the edible liner by using an edible ink composition.

14. The method according to claim 12, wherein said printing of said 3D configuration sculpture product comprises an edible baking liner in a shape having a bottom, substantially vertical wall and an open top.

15. The method according to claim 12, wherein comprising the step of forming a cupcake shape for accommodating baked material.

16. The method according to claim 12, wherein said method additionally comprising step of selecting a structure from the group consisting of: cupcake, cup shape, baking tin shape, a pan shape, a tray shape, a plate shape and a combination thereof.

17. The method according to claim 12, wherein said method additionally comprising step of adding to said edible baking liner at least one of the following components selected from the group consisting of: a color, a flavor, an odor-imparting agent, corn syrup solids and a combination thereof.

18. The method according to claim 12, wherein said edible material is substantially stable in low relative humidity environments.

19. The method according to claim 12, wherein said edible material is substantially stable when exposed to a temperature above about 90° C.

20. The method according to claim 12, wherein said method additionally comprising step of cutting the edible baking liner into a desired texture.
